(19) United States
(12) Patent Application Publication
(10) Pub. No.: US 2021/0192243 A1
(43) Pub. Date: Jun. 24, 2021

(54) METHOD, SYSTEM, AND COMPUTER-READABLE MEDIUM FOR GENERATING SPOOFED STRUCTURED LIGHT ILLUMINATED FACE

(71) Applicant: GUANGDONG OPPO MOBILE TELECOMMUNICATIONS CORP., LTD., Dongguan (CN)

(72) Inventors: Yuan LIN, Palo Alto, CA (US); Chiuman HO, Palo Alto, CA (US)

(21) Appl. No.: 17/197,570

(22) Filed: Mar. 10, 2021

Related U.S. Application Data
(63) Continuation of application No. PCT/CN2019/104232, filed on Sep. 3, 2019.
(60) Provisional application No. 62/732,783, filed on Sep. 18, 2018.

(51) Int. Cl. G06K 9/00; G06K 9/20; H04N 13/243; H04N 13/111; G06T 13/40; G06T 13/80

(52) U.S. Cl. CPC G06K 9/00899; G06K 9/2036; G06K 9/00288; G06K 9/00255; G06K 2209/401; H04N 13/111; G06K 9/00281; G06T 13/40; G06T 13/80; H04N 13/243

(57) ABSTRACT

In an embodiment, a method includes determining a spatial illumination distribution using a first image caused by at least first structured light and a second image caused by at least second structured light, wherein a portion of the first image is caused by a portion of the at least first structured light traveling a first distance, a portion of the second image is caused by a portion of the at least second structured light traveling a second distance, the portion of the first image and the portion of the second image cause a same portion of the spatial illumination distribution, and the first distance is different from the second distance; building a first 3D face model; rendering the first 3D face model using the spatial illumination distribution, to generate a first rendered 3D face model; and displaying the first rendered 3D face model to a first camera.

### CROSS-REFERENCE TO RELATED APPLICATION

This application is a continuation of International Application No. PCT/CN2019/104232, filed on Sep. 3, 2019, which claims priority to U.S. Provisional Application No. 62/732,783, filed on Sep. 18, 2018. The entire disclosures of the aforementioned applications are incorporated herein by reference.

### BACKGROUND OF THE DISCLOSURE

### 1. Field of the Disclosure

The present disclosure relates to the field of testing security of face recognition systems, and more particularly, to a method, system, and computer-readable medium for generating a spoofed structured light illuminated face for testing security of a structured light-based face recognition system.

### 2. Description of the Related Art

Over the past few years, biometric authentication using face recognition has become increasingly popular for mobile devices and desktop computers because of the advantages of security, fast speed, convenience, accuracy, and low cost. Understanding limits of face recognition systems can help developers design more secure face recognition systems that have fewer weak points or loopholes that can be attacked by spoofed faces.

### SUMMARY

An object of the present disclosure is to propose a method, system, and computer-readable medium for generating a spoofed structured light illuminated face for testing security of a structured light-based face recognition system.

In a first aspect of the present disclosure, a method includes:

determining, by at least one processor, a first spatial illumination distribution using a first image caused by at least first structured light and a second image caused by at least second structured light, wherein a first portion of the first image is caused by a first portion of the at least first structured light traveling a first distance, a first portion of the second image is caused by a first portion of the at least second structured light traveling a second distance, the first portion of the first image and the first portion of the second image cause a same portion of the first spatial illumination distribution, and the first distance is different from the second distance;

building, by the at least one processor, a first 3D face model;

rendering, by the at least one processor, the first 3D face model using the first spatial illumination distribution, to generate a first rendered 3D face model; and

displaying, by a first display, the first rendered 3D face model to a first camera for testing a face recognition system.

According to an embodiment in conjunction with the first aspect of the present disclosure, the step of determining the first spatial illumination distribution using the first image caused by the at least first structured light and the second image caused by the at least second structured light includes: determining the first spatial illumination distribution using the first image caused only by the first structured light and the second image caused only by the second structured light, wherein the first portion of the first image is caused by a first portion of the first structured light traveling the first distance, the first portion of the second image is caused by a first portion of the second structured light traveling the second distance; and the method further includes: determining a second spatial illumination distribution using a third image caused only by first non-structured light and a fourth image caused only by second non-structured light, wherein a first portion of the third image is caused by a first portion of the first non-structured light traveling a third distance, a first portion of the fourth image is caused by a first portion of the second non-structured light traveling a fourth distance, the first portion of the third image and the first portion of the fourth image cause a same portion of the second spatial illumination distribution, and the third distance is different from the fourth distance.

According to an embodiment in conjunction with the first aspect of the present disclosure, the method further includes:

illuminating a first projection surface with the first non-structured light;

capturing the third image, wherein the third image reflects a third spatial illumination distribution on the first projection surface illuminated by the first non-structured light;

illuminating a second projection surface with the second non-structured light; and

capturing the fourth image, wherein the fourth image reflects a fourth spatial illumination distribution on the second projection surface illuminated by the second non-structured light;

wherein the first projection surface is or is not the second projection surface.

According to an embodiment in conjunction with the first aspect of the present disclosure, the method further includes:

projecting to a first projection surface with the at least first structured light, wherein the at least first structured light is unbent by any optical element before traveling to the first projection surface; and

capturing the first image, wherein the first image reflects a fifth spatial illumination distribution on the first projection surface illuminated by the at least first structured light;

projecting to a second projection surface with the at least second structured light, wherein the at least second structured light is unbent by any optical element before traveling to the second projection surface; and

capturing the second image, wherein the second image reflects a sixth spatial illumination distribution on the second projection surface illuminated by the at least second structured light;

wherein the first projection surface is or is not the second projection surface.

According to an embodiment in conjunction with the first aspect of the present disclosure, the method further includes:

projecting to a first projection surface and a second projection surface with at least third structured light, wherein the at least third structured light is reflected by a reflecting optical element and split by a splitting optical element into the at least first structured light and the at least second structured light correspondingly traveling to the first projection surface and the second projection surface;

capturing the first image, wherein the first image reflects a seventh spatial illumination distribution on the first projection surface illuminated by the at least first structured light; and

capturing the second image, wherein the second image reflects an eighth spatial illumination distribution on the second projection surface illuminated by the at least second structured light.

According to an embodiment in conjunction with the first aspect of the present disclosure, the method further includes:

capturing the first image and the second image by at least one camera.

According to an embodiment in conjunction with the first aspect of the present disclosure, the step of building the first 3D face model includes:

perform scaling such that the first 3D face model is scaled in accordance with a fifth distance between the first display and the first camera when the first rendered 3D face model is displayed by the first display to the first camera.

According to an embodiment in conjunction with the first aspect of the present disclosure, the step of building the 3D face model includes:

extracting facial landmarks using a plurality of photos of a target user;

reconstructing a neutral-expression 3D face model using the facial landmarks;

patching the neutral-expression 3D face model with facial texture in one of the photos, to obtain a patched 3D face model;

scaling the patched 3D face model in accordance with a fifth distance between the first display and the first camera when the first rendered 3D face model is displayed by the first display to the first camera, to obtain a scaled 3D face model;

performing gaze correction such that eyes of the scaled 3D face model look straight towards the first camera, to obtain a gaze corrected 3D face model; and

animating the gaze corrected 3D face model with a pre-defined set of facial expressions, to obtain the first 3D face model.

In a second aspect of the present disclosure, a system includes at least one memory, at least one processor, and a first display. The at least one memory is configured to store program instructions. The at least one processor is configured to execute the program instructions, which cause the at least one processor to perform steps including:

determining a first spatial illumination distribution using a first image caused by at least first structured light and a second image caused by at least second structured light, wherein a first portion of the first image is caused by a first portion of the at least first structured light traveling a first distance, a first portion of the second image is caused by a first portion of the at least second structured light traveling a second distance, the first portion of the first image and the first portion of the second image cause a same portion of the first spatial illumination distribution, and the first distance is different from the second distance;

building a first 3D face model; and

rendering the first 3D face model using the first spatial illumination distribution, to generate a first rendered 3D face model.

The first display is configured to display the first rendered 3D face model to a first camera for testing a face recognition system.

According to an embodiment in conjunction with the second aspect of the present disclosure, the step of determining the first spatial illumination distribution using the first image caused by the at least first structured light and the second image caused by the at least second structured light includes: determining a first spatial illumination distribution using the first image caused only by the first structured light and the second image caused only by the second structured light, wherein the first portion of the first image is caused by a first portion of the first structured light traveling the first distance, the first portion of the second image is caused by a first portion of the second structured light traveling the second distance; and the method further includes: determining a second spatial illumination distribution using a third image caused only by first non-structured light and a fourth image caused only by second non-structured light, wherein a first portion of the third image is caused by a first portion of the first non-structured light traveling a third distance, a first portion of the fourth image is caused by a first portion of the second non-structured light traveling a fourth distance, the first portion of the third image and the first portion of the fourth image cause a same portion of the second spatial illumination distribution, and the third distance is different from the fourth distance.

According to an embodiment in conjunction with the second aspect of the present disclosure, the system further includes:

a first projection surface configured to be illuminated with the first non-structured light, wherein a third spatial illumination distribution on the first projection surface is reflected in the third image, and the third image is captured by the first camera; and

a second projection surface configured to be illuminated with the second non-structured light, wherein a fourth spatial illumination distribution on the second projection surface is reflected in the fourth image, and the fourth image is captured by the first camera;

wherein the first projection surface is or is not the second projection surface.

According to an embodiment in conjunction with the second aspect of the present disclosure, the system further includes:

a first non-structured light illuminator;

a first projection surface and a second projection surface, wherein the first projection surface is or is not the second projection surface; and

a second camera, wherein the second camera is or is not the first camera;

wherein
the first non-structured light illuminator is configured to illuminate the first projection surface with the first non-structured light;
the second camera is configured to capture the third image, wherein the third image reflects a third spatial illumination distribution on the first projection surface illuminated by the first non-structured light;
the first non-structured light illuminator is further configured to illuminate the second projection surface with the second non-structured light; and
the second camera is further configured to capture the fourth image, wherein the fourth image reflects a fourth spatial illumination distribution on the second projection surface illuminated by the second non-structured light.

According to an embodiment in conjunction with the second aspect of the present disclosure, the system further includes:

a first projection surface configured for projection with the at least first structured light to be performed to the first projection surface, wherein the at least first structured light is unbent by any optical element before traveling to the first projection surface, a fifth spatial illumination distribution on the first projection surface is reflected in the first image, and the first image is captured by the first camera; and

a second projection surface configured for projection with the at least second structured light to be performed to the second projection surface, wherein the at least second structured light is unbent by any optical element before traveling to the second projection surface, a sixth spatial illumination distribution on the second projection surface is reflected in the second image, and the second image is captured by the first camera;

wherein the first projection surface is or is not the second projection surface.

According to an embodiment in conjunction with the second aspect of the present disclosure, the system further includes:

at least first structured light projector;

a first projection surface and a second projection surface, wherein the first projection surface is or is not the second projection surface; and

a second camera, wherein the second camera is or is not the first camera;

wherein
the at least first structured light projector is configured to project to the first projection surface with the at least first structured light, wherein the at least first structured light is unbent by any optical element before traveling to the first projection surface;
the second camera is configured to capture the first image, wherein the first image reflects a fifth spatial illumination distribution on the first projection surface illuminated by the at least first structured light;
the at least first structured light projector is further configured to project to the second projection surface with the at least second structured light, wherein the at least second structured light is unbent by any optical element before traveling to the second projection surface; and
the second camera is further configured to capture the second image, wherein the second image reflects a sixth spatial illumination distribution on the second projection surface illuminated by the at least second structured light.

According to an embodiment in conjunction with the second aspect of the present disclosure, the system further includes:

a first projection surface and a second projection surface configured for projection with at least third structured light to be performed to the first projection surface and the second projection surface;

wherein
the at least third structured light is reflected by a reflecting optical element and split by a splitting optical element into the at least first structured light and the at least second structured light correspondingly traveling to the first projection surface and the second projection surface;
a seventh spatial illumination distribution on the first projection surface is reflected in the first image, and the first image is captured by the first camera; and
an eighth spatial illumination distribution on the second projection surface is reflected in the second image, and the second image is captured by the first camera.

According to an embodiment in conjunction with the second aspect of the present disclosure, the system further includes:

at least first structured light projector;

a first projection surface and a second projection surface; and

a second camera;

a third camera;

wherein
the at least first structured light projector is configured to project to the first projection surface and the second projection surface with at least third structured light;
the at least third structured light is reflected by a reflecting optical element and split by a splitting optical element into the at least first structured light and the at least second structured light correspondingly traveling to the first projection surface and the second projection surface;
the second camera is configured to capture the first image, wherein the first image reflects a seventh spatial illumination distribution on the first projection surface illuminated by the at least first structured light; and
the third camera is configured to capture the second image, wherein the second image reflects an eighth spatial illumination distribution on the second projection surface illuminated by the at least second structured light.

According to an embodiment in conjunction with the second aspect of the present disclosure, the system further includes:

at least one camera configured to capture the first image and the second image.

According to an embodiment in conjunction with the second aspect of the present disclosure, the step of building the first 3D face model includes:

perform scaling such that the first 3D face model is scaled in accordance with a fifth distance between the first display and the first camera when the first rendered 3D face model is displayed by the first display to the first camera.

According to an embodiment in conjunction with the second aspect of the present disclosure, the step of building the 3D face model includes:

extracting facial landmarks using a plurality of photos of a target user;

reconstructing a neutral-expression 3D face model using the facial landmarks;

patching the neutral-expression 3D face model with facial texture in one of the photos, to obtain a patched 3D face model;

scaling the patched 3D face model in accordance with a fifth distance between the first display and the first camera when the first rendered 3D face model is displayed by the first display to the first camera, to obtain a scaled 3D face model;

performing gaze correction such that eyes of the scaled 3D face model look straight towards the first camera, to obtain a gaze corrected 3D face model; and

animating the gaze corrected 3D face model with a pre-defined set of facial expressions, to obtain the first 3D face model.

In a third aspect of the present disclosure, a non-transitory computer-readable medium with program instructions stored thereon is provided. When the program instructions are executed by at least one processor, the at least one processor is caused to perform steps including:

determining a first spatial illumination distribution using a first image caused by at least first structured light and a second image caused by at least second structured light, wherein a first portion of the first image is caused by a first portion of the at least first structured light traveling a first distance, a first portion of the second image is caused by a first portion of the at least second structured light traveling a second distance, the first portion of the first image and the first portion of the second image cause a same portion of the first spatial illumination distribution, and the first distance is different from the second distance;

building a first 3D face model;

rendering the first 3D face model using the first spatial illumination distribution, to generate a first rendered 3D face model; and

causing a first display to display the first rendered 3D face model to a first camera for testing a face recognition system.

### BRIEF DESCRIPTION OF THE DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram illustrating a spoofed structured light illuminated face generation system used to test a structured light-based face recognition system in accordance with an embodiment of the present disclosure.

FIG. 2 is a block diagram illustrating the spoofed structured light illuminated face generation system in accordance with an embodiment of the present disclosure.

FIG. 3 is a structural diagram illustrating a first setup for calibrating static structured light illumination in accordance with an embodiment of the present disclosure.

FIG. 4 is a structural diagram illustrating a second setup for calibrating the static structured light illumination in accordance with an embodiment of the present disclosure.

FIG. 5 is a structural diagram illustrating a first setup for calibrating static non-structured light illumination in accordance with an embodiment of the present disclosure.

FIG. 6 is a structural diagram illustrating a second setup for calibrating the static non-structured light illumination in accordance with an embodiment of the present disclosure.

FIG. 7 is a block diagram illustrating a hardware system for implementing a software module for displaying a first rendered 3D face model in accordance with an embodiment of the present disclosure.

FIG. 8 is a flowchart illustrating a method for building a first 3D face model in accordance with an embodiment of the present disclosure.

FIG. 9 is a structural diagram illustrating a setup for displaying the first rendered 3D face model to a camera in accordance with an embodiment of the present disclosure.

FIG. 10 is a structural diagram illustrating a setup for calibrating dynamic structured light illumination and displaying a first rendered 3D face model to a camera in accordance with an embodiment of the present disclosure.

FIG. 11 is a flowchart illustrating a method for generating a spoofed structured light illuminated face in accordance with an embodiment of the present disclosure.

FIG. 12 is a flowchart illustrating a method for generating a spoofed structured light illuminated face in accordance with another embodiment of the present disclosure.

### DETAILED DESCRIPTION OF THE EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the invention.

As used here, the term “using” refers to a case in which an object is directly employed for performing a step, or a case in which the object is modified by at least one intervening step and the modified object is directly employed to perform the step.

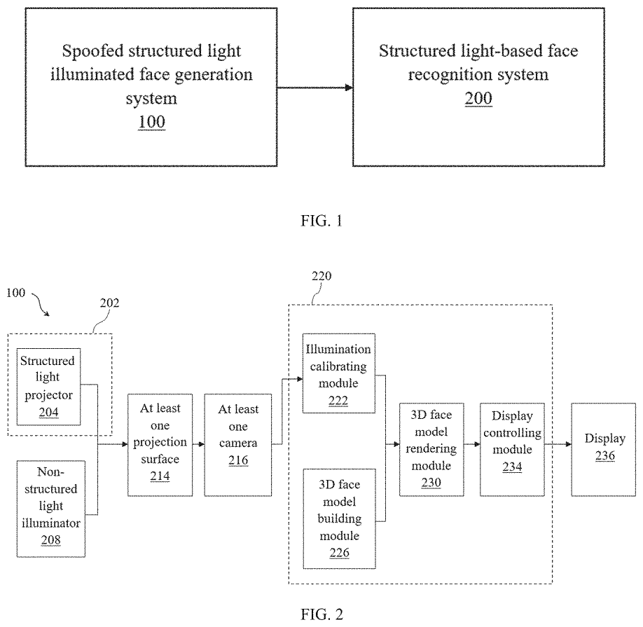

FIG. 1 is a block diagram illustrating a spoofed structured light illuminated face generation system 100 used to test a structured light-based face recognition system 200 in accordance with an embodiment of the present disclosure. The spoofed structured light illuminated face generation system 100 is a 3D spoofed face generation system configured to generate a spoofed structured light illuminated face of a target user. The structured light-based face recognition system 200 is a 3D face recognition system configured to authenticate whether a face presented to the structured light-based face recognition system 200 is the face of the target user. By presenting the spoofed structured light illuminated face generated by the spoofed structured light illuminated face generation system 100 to the structured light-based face recognition system 200, security of the structured light-based face recognition system 200 is tested. The structured light-based face recognition system 200 may be a portion of a mobile device or a desktop computer. The mobile device is, for example, a mobile phone, a tablet, or a laptop computer.

FIG. 2 is a block diagram illustrating the spoofed structured light illuminated face generation system 100 in accordance with an embodiment of the present disclosure. Referring to FIG. 2, the spoofed structured light illuminated face generation system 100 includes at least structured light projector 202, at least one projection surface 214, at least one camera 216, a software module 220 for displaying a first rendered 3D face model, and a display 236. The at least structured light projector 202, the at least one projection surface 214, the at least one camera 216, and the display 236 are hardware modules. The software module 220 for displaying the first rendered 3D face model includes an illumination calibrating module 222, an 3D face model building module 226, an 3D face model rendering module 230, and a display controlling module 234.

The at least structured light projector 202 is configured to project to one of the at least one projection surface 214 with at least first structured light. The one of the at least one projection surface 214 is configured to display a first spatial illumination distribution caused by the at least first structured light. One of the at least one camera 216 is configured to capture a first image. The first image reflects the first spatial illumination distribution. A first portion of the first image is caused by a first portion of the at least first structured light traveling a first distance to reach the one of the at least one projection surface 214. The at least structured light projector 202 is further configured to project to the same one or a different one of the at least one projection surface 214 with at least second structured light. The same one or the different one of the at least one projection surface 214 is further configured to display a second spatial illumination distribution caused by the at least second structured light. The same one or a different one of the at least one camera 216 is further configured to capture a second image. The second image reflects the second spatial illumination distribution. A first portion of the second image is caused by a first portion of the at least second structured light traveling a second distance to reach the same one or the different one of the at least one projection surface 214. The first distance is different from the second distance. The illumination calibrating module 222 is configured to determine a third spatial illumination distribution using the first image and the second image. The first portion of the first image and the first portion of the second image cause a same portion of the third spatial illumination distribution. The 3D face model building module 226 is configured to build a first 3D face model. The 3D face model rendering module 230 is configured to render the first 3D face model using the third spatial illumination distribution, to generate the first rendered 3D face model. The display controlling module 234 is configured to cause the display 236 to display the first rendered 3D face model to a first camera. The display 236 is configured to display the first rendered 3D face model to the first camera.

In an embodiment, the at least structured light projector 202 is a structured light projector 204. The structured light projector 204 is configured to project to the one of the at least one projection surface 214 with only first structured light. The first spatial illumination distribution is caused only by the first structured light. The first portion of the first image is caused by a first portion of the first structured light traveling the first distance to reach the one of the at least one projection surface 214. The structured light projector 204 is further configured to project to the same one or the different one of the at least one projection surface 214 with only second structured light. The second spatial illumination distribution is caused only by the second structured light. The first portion of the second image is caused by a first portion of the second structured light traveling the second distance to reach the same one or the different one of the at least one projection surface 214. The spoofed structured light illuminated face generation system 100 further includes a non-structured light illuminator 208. The non-structured light illuminator 208 is configured to illuminate the one of the at least one projection surface 214 with only first non-structured light. The one of the at least one projection surface 214 is further configured to display a fourth spatial illumination distribution caused only by the first non-structured light. The one of the at least one camera 216 is further configured to capture a third image. The third image reflects the fourth spatial illumination distribution. A first portion of the third image is caused by a first portion of the first non-structured light traveling a third distance to reach the one of the at least one projection surface 214. The non-structured light illuminator 208 is further configured to illuminate the same one or the different one of the at least one projection surface 214 with only second non-structured light. The same one or the different one of the at least one projection surface 214 is further configured to display a fifth spatial illumination distribution caused only by the second non-structured light. The same one or the different one of the at least one camera 216 is further configured to capture a fourth image. The fourth image reflects the fifth spatial illumination distribution. A first portion of the fourth image is caused by a first portion of the second non-structured light traveling a fourth distance to reach the same one or the different one of the at least one projection surface 214. The third distance is different from the fourth distance. The third distance may be same as the first distance. The fourth distance may be same as the second distance. The illumination calibrating module 222 is further configured to determine a sixth spatial illumination distribution using the third image and the fourth image. The first portion of the third image and the first portion of the fourth image cause a same portion of the sixth spatial illumination distribution. The 3D face model rendering module 230 is configured to render the first 3D face model using the third spatial illumination distribution and the sixth spatial illumination distribution, to generate the first rendered 3D face model.

Alternatively, the 3D face model rendering module 230 is configured to render the first 3D face model using the third spatial illumination distribution, to generate the first rendered 3D face model, and render the first 3D face model using the sixth spatial illumination distribution, to generate a second rendered 3D face model. The display controlling module 234 is configured to cause the display 236 to display the first rendered 3D face model and the second rendered 3D face model to the first camera. The display 236 is configured to display the first rendered 3D face model and the second rendered 3D face model to the first camera. A person having ordinary skill in the art will understand that other rendering alternatives now known or hereafter developed, may be used for spoofing the corresponding structured light-based face recognition system 200.

Still alternatively, the at least structured light projector 202 includes a structured light projector 204 and a non-structured light illuminator 208. The structured light projector 204 is configured to project to the one of the at least one projection surface 214 with only first structured light. The non-structured light illuminator 208 is configured to illuminate the one of the at least one projection surface 214 with only first non-structured light. The first spatial illumination distribution is caused by a combination of the first structured light and the first non-structured light. The first portion of the first image is caused by a first portion of the combination of the first structured light and the first non-structured light traveling the first distance to reach the one of the at least one projection surface 214. The structured light projector 204 is further configured to project to the same one or the different one of the at least one projection surface 214 with only second structured light. The non-structured light illuminator 208 is further configured to illuminate the same one or the different one of the at least one projection surface 214 with only second non-structured light. The second spatial illumination distribution is caused by a combination of the second structured light and the second non-structured light. The first portion of the second image is caused by a first portion of the combination of the second structured light and the second non-structured light traveling the second distance to reach the same one or the different one of the at least one projection surface 214. A person having ordinary skill in the art will understand that other light source alternatives and illumination calibration alternatives now known or hereafter developed, may be used for rendering the first 3D face model.

In an embodiment, the structured light projector 204 is a dot projector. The first spatial illumination distribution and the second spatial illumination distribution are spatial point cloud distributions. A spatial point cloud distribution includes shape information, location information, and intensity information of a plurality of point clouds. Alternatively, the structured light projector 204 is a stripe projector. The first spatial illumination distribution and the second spatial illumination distribution are spatial stripe distributions. A spatial stripe distribution includes shape information, location information, and intensity information of a plurality of stripes. A person having ordinary skill in the art will understand that other projector alternatives now known or hereafter developed, may be used for rendering the first 3D face model.

In an embodiment, the structured light projector 204 is an infrared structured light projector. The non-structured light illuminator 208 is an infrared non-structured light illuminator such as a flood illuminator. The at least one camera 216 is at least one infrared camera. The display 236 is an infrared display. The first camera is an infrared camera. Alternatively, the structured light projector 204 is a visible structured light projector. The non-structured light illuminator 208 is a visible non-structured light illuminator. The at least one camera 216 is at least one visible light camera. The display 236 is a visible light display. The first camera is a visible light camera. A person having ordinary skill in the art will understand that other light alternatives now known or hereafter developed, may be used for spoofed structured light illuminated face generation and structured light-based face recognition.

In an embodiment, the one and the different one of the at least one projection surface 214 are surfaces of corresponding projection screens. Alternatively, the one of the at least one projection surface 214 is a surface of a wall. A person having ordinary skill in the art will understand that other projection surface alternatives now known or hereafter developed, may be used for rendering the first 3D face model.

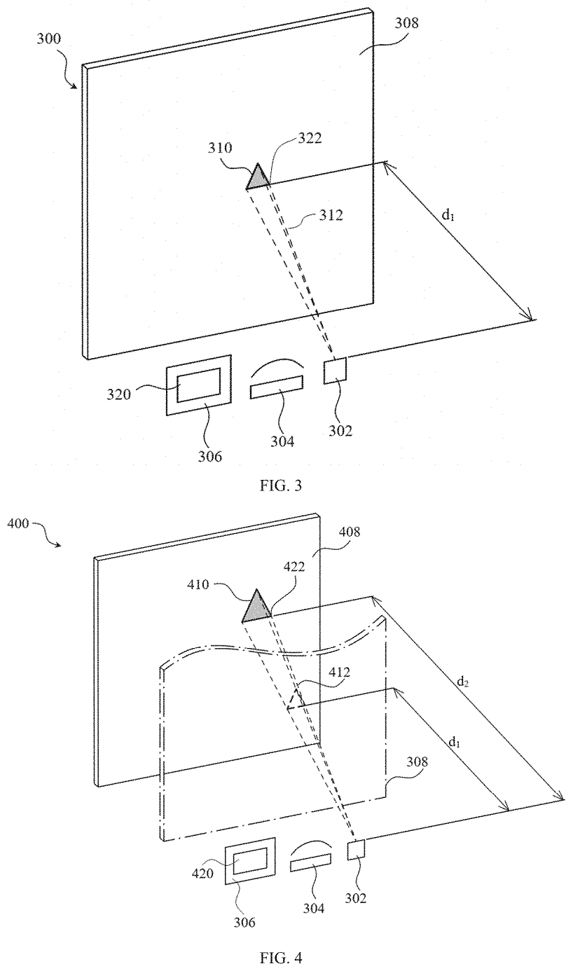

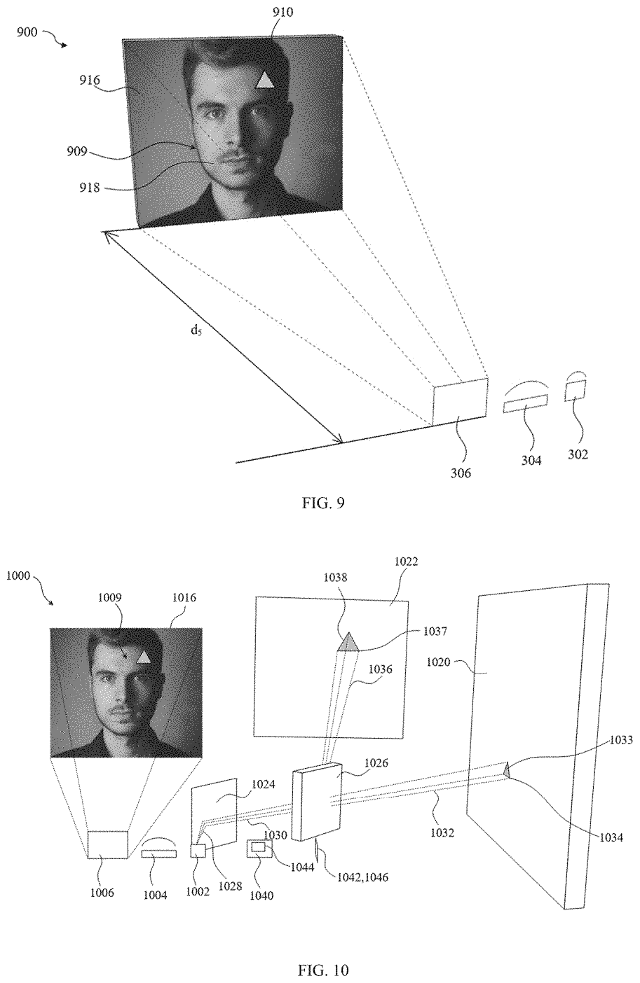

In an embodiment, the structured light projector 204, the non-structured light illuminator 208, and the first camera are parts of the structured light-based face recognition system 200 (shown in FIG. 1) configured to illuminate the face of the target user and capture illuminated face of the target user for authentication. The at least one camera 216 is a camera 306 to be described with reference to FIG. 3. The first camera is the camera 306 to be described with reference to FIG. 9. Alternatively, the structured light projector 204, the non-structured light illuminator 208, and/or the camera 306 are not parts of the structured light-based face recognition system 200, but are of same corresponding component types as corresponding components of the structured light-based face recognition system 200. In another embodiment, the structured light projector 204, the non-structured light illuminator 208, and the first camera are parts of the structured light-based face recognition system 200. The at least one camera 216 is a camera 1040 and a camera 1042 to be described with reference to FIG. 10, and the first camera is a camera 1006 to be described with reference to FIG. 10. The camera 1040 and the camera 1042 are same type of cameras as the camera 1006. A person having ordinary skill in the art will understand that other source of component alternatives now known or hereafter developed, may be used for spoofed structured light illuminated face generation.

FIG. 3 is a structural diagram illustrating a first setup 300 for calibrating static structured light illumination in accordance with an embodiment of the present disclosure. Referring to FIGS. 2 and 3, the first setup 300 is for implementing steps related to the first spatial illumination distribution performed by the structured light projector 204, the at least one projection surface 214, and the at least one camera 216. The first setup 300 is a setup at time t₁. In FIG. 2, the structured light projector 204 is configured to project to the one of the at least one projection surface 214 with only the first structured light. In the first setup 300, a structured light projector 302 is configured to project to a projection screen 308 with only the first structured light. Anon-structured light illuminator 304 is covered by a lens cover. In FIG. 2, the one of the at least one projection surface 214 is configured to display the first spatial illumination distribution caused only by the first structured light. In the first setup 300, the projection screen 308 is configured to display the first spatial point cloud distribution caused only by the first structured light. The first spatial point cloud distribution includes shape information, location information, and intensity information of a plurality of first point clouds. Each first point cloud has, for example, a triangular shape, or a circular shape. One 310 of the first point clouds having a triangular shape is exemplarily illustrated in FIG. 3. A portion of the first structured light causing corners of the first point cloud 310 is exemplarily illustrated as dashed lines. Other first point clouds and other portions of the first structured light are not shown in FIG. 3 for simplicity. The projection screen 308 is located with respect to the structured light projector 302 such that a corner 322 of the first point cloud 310 is caused by a portion 312 of the first structured light traveling a distance d₁ to reach the projection screen 308. The first structured light is unbent by any optical element before traveling to the projection screen 308. In FIG. 2, the one of the at least one camera 216 is configured to capture the first image. The first image reflects the first spatial illumination distribution. The first portion of the first image is caused by the first portion of the first structured light traveling the first distance to reach the one of the at least one projection surface 214. In the first setup 300, a camera 306 is configured to capture an image 320. The image 320 reflects the entire first spatial point cloud distribution. A portion of the image 320 reflecting the corner 322 of the point cloud 310 is caused by the portion 312 of the first structured light.

FIG. 4 is a structural diagram illustrating a second setup 400 for calibrating the static structured light illumination in accordance with an embodiment of the present disclosure. Referring to FIGS. 2 and 4, the second setup 400 is for implementing steps related to the second spatial illumination distribution performed by the structured light projector 204, the at least one projection surface 214, and the at least one camera 216. The second setup 400 is a setup at time t₂. Time t₂ is later than time t₁. In FIG. 2, the structured light projector 202 is further configured to project to the same one or the different one of the at least one projection surface 214 with only the second structured light. In the second setup 400, the structured light projector 302 is further configured to project to a projection screen 408 with only the second structured light. The non-structured light illuminator 304 is covered by the lens cover. In FIG. 2, the same one or the different one of the at least one projection surface 214 is further configured to display the second spatial illumination distribution caused only by the second structured light. In the second setup 400, the projection screen 408 is further configured to display a second spatial point cloud distribution caused only by the second structured light. The second spatial point cloud distribution includes shape information, location information, and intensity information of a plurality of second point clouds. Each second point cloud has, for example, a triangular shape, or a circular shape. One 410 of the second point clouds having a triangular shape is exemplarily illustrated in FIG. 4. A portion of the second structured light causing corners of the second point cloud 410 is exemplarily illustrated as dashed lines. Other second point clouds and other portions of the second structured light are not shown in FIG. 4 for simplicity. The projection screen 408 is located with respect to the structured light projector 302 such that a corner 422 of the second point cloud 410 is caused by a portion 412 of the second structured light traveling a distance d₂ to reach the projection screen 408. The distance d₂ is longer than the distance d₁. The second structured light is unbent by any optical element before traveling to the projection screen 408. A path of the portion 412 of the second structured light is overlapped with a path of the portion 312 (labeled in FIG. 3) of the first structured light such that the second point cloud 410 is an enlarged version of the first point cloud 310 (labeled in FIG. 3). The projection screen 408 may be the same projection screen 308 in FIG. 3. In FIG. 2, the same one or the different one of the at least one camera 216 is further configured to capture the second image. The second image reflects the second spatial illumination distribution. The first portion of the second image is caused by the first portion of the second structured light traveling the second distance to reach the same one or the different one of the at least one projection surface 214. The first distance is different from the second distance. In the second setup 400, the camera 306 is further configured to capture an image 420. The image 420 reflects the entire second spatial point cloud distribution. A portion of the image 420 reflecting the corner 422 of the point cloud 410 is caused by the portion 412 of the second structured light.

Referring to FIG. 2, the illumination calibrating module 222 is configured to determine the third spatial illumination distribution using the first image and the second image. The first portion of the first image and the first portion of the second image cause the same portion of the third spatial illumination distribution. Referring to FIGS. 2, 3 and 4, the illumination calibrating module 222 is configured to determine the third spatial point cloud distribution using the image 320 and the image 420. A portion of the image 320 corresponding to the corner 322 of the point cloud 310 and a portion of the image 420 corresponding to the corner 422 of the point cloud 410 cause a same corner of the third spatial point cloud distribution. The third spatial point cloud distribution is a calibrated version of a spatial point cloud distribution of the structured light projector 302. The first spatial point cloud distribution and the second spatial point cloud distribution are originated from the spatial point cloud distribution of the structured light projector 302. Calibration of the spatial point cloud distribution of the structured light projector 302 may involve performing extrapolation on the first spatial point cloud distribution and the second spatial point cloud distribution, to obtain the third spatial point cloud distribution. Other setups such that interpolation is performed for calibrating the spatial point cloud distribution of the structured light projector 302 is within the contemplated scope of the present disclosure. Intensity information of the third spatial point cloud distribution is calibrated using the inverse-square law. Calibration of the spatial illumination distribution of the structured light projector 302 may use the distances d₁ and d₂. The spatial point cloud distribution of the structured light projector 302 is static throughout the structured light-based face recognition system 200 (shown in FIG. 1) illuminating the face of the target user with structured light and capturing structured light illuminated face of the target user, and therefore may be pre-calibrated using the first setup 300 and the second setup 40.

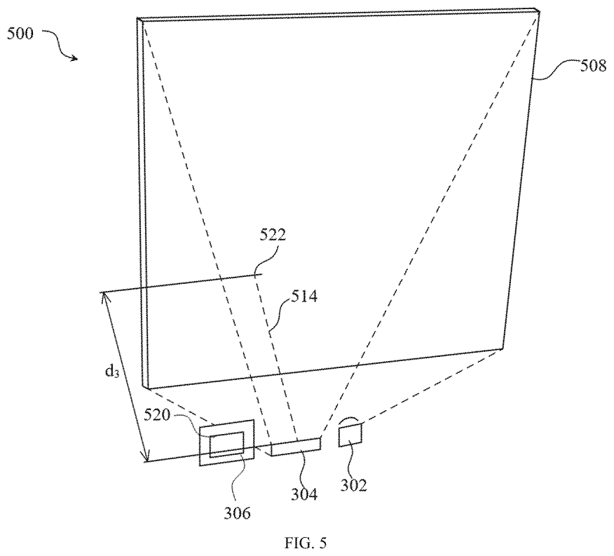

FIG. 5 is a structural diagram illustrating a first setup 500 for calibrating static non-structured light illumination in accordance with an embodiment of the present disclosure. Referring to FIGS. 2 and 5, the first setup 500 is for implementing steps related to the fourth spatial illumination distribution performed by the non-structured light illuminator 208, the at least one projection surface 214, and the at least one camera 216. The first setup 500 is a setup at time 3. Time t₃ is different from time t₁ and t₂ described with reference to FIGS. 3 and 4. In FIG. 2, the non-structured light illuminator 208 is configured to illuminate the one of the at least one projection surface 214 with only the first non-structured light. In the first setup 500, a non-structured light illuminator 304 is configured to illuminate a projection screen 508 with only the first non-structured light. The projection screen 508 may be the same projection screen 308. The structured light projector 302 is covered by a lens cover. In FIG. 2, the one of the at least one projection surface 214 is further configured to display the fourth spatial illumination distribution caused only by the first non-structured light. In the first setup 500, the projection screen 508 is configured to display the fourth spatial illumination distribution caused only by the first non-structured light. The fourth spatial illumination distribution includes intensity information of the first non-structured light. A portion of the first non-structured light illuminating the projection screen 508 is exemplarily illustrated as dashed lines. Other portions of the first non-structured light are not shown in FIG. 5 for simplicity. The projection screen 308 is located with respect to the non-structured light illuminator 304 such that an illuminated portion 522 of the projection screen 508 is caused by a portion 514 of the first non-structured light traveling a distance d₃ to reach the projection screen 508. The first non-structured light is unbent by any optical element before traveling to the projection screen 508. In FIG. 2, the one of the at least one camera 216 is further configured to capture the third image. The third image reflects the fourth spatial illumination distribution. The first portion of the third image is caused by the first portion of first non-structured light traveling the third distance to reach the one of the at least one projection surface 214. In the first setup 500, the camera 306 is configured to capture an image 520. The image 520 reflects the entire fourth spatial illumination distribution. A portion of the image 520 reflecting the illuminated portion 522 of the projection screen 508 is caused by the portion 514 of the first non-structured light.

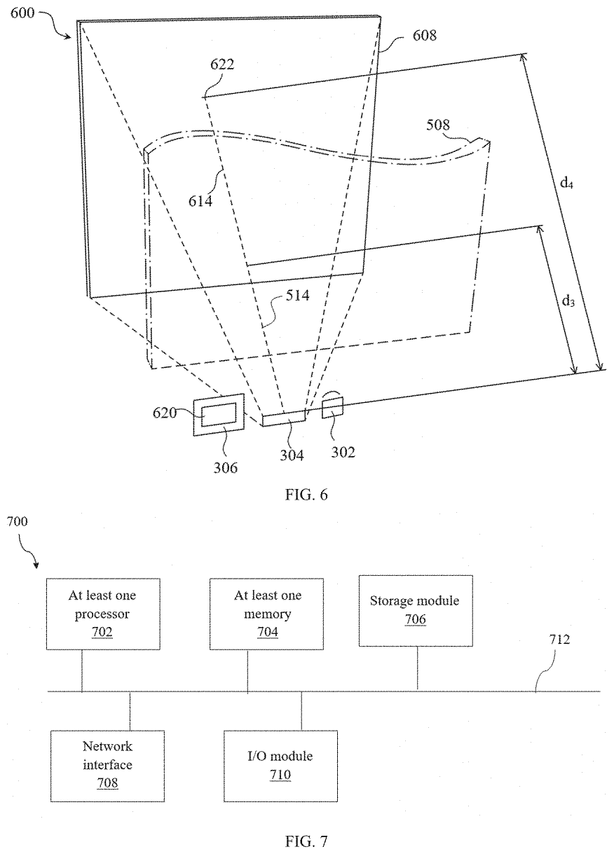

FIG. 6 is a structural diagram illustrating a second setup 600 for calibrating the static non-structured light illumination in accordance with an embodiment of the present disclosure. Referring to FIGS. 2 and 6, the second setup 600 is for implementing steps related to the fifth spatial illumination distribution performed by the non-structured light illuminator 208, the at least one projection surface 214, and the at least one camera 216. The second setup 600 is a setup at time t₄. Time t₄ is later than time t₃. In FIG. 2, the non-structured light illuminator 208 is further configured to illuminate the same one or the different one of the at least one projection surface 214 with only the second non-structured light. In the second setup 600, the non-structured light illuminator 304 is further configured to illuminate a projection screen 608 with only the second non-structured light. The structured light projector 302 is covered by the lens cover. In FIG. 2, the same one or the different one of the at least one projection surface 214 is further configured to display the fifth spatial illumination distribution caused only by the second non-structured light. In the second setup 600, the projection screen 608 is further configured to display the fifth spatial illumination distribution caused only by the second non-structured light. The fifth spatial illumination distribution includes intensity information of the second non-structured light. A portion of the second non-structured light illuminating the projection screen 608 is exemplarily illustrated as dashed lines. Other portions of the second non-structured light are not shown in FIG. 6 for simplicity. The projection screen 608 is located with respect to the non-structured light illuminator 304 such that an illuminated portion 622 of the projection screen 608 is caused by a portion 614 of the second non-structured light traveling a distance d₄ to reach the projection screen 608. The distance d₄ is longer than the distance d₃. The second non-structured light is unbent by any optical element before traveling to the projection screen 608. A path of the portion 614 of the second non-structured light is overlapped with a path of the portion 514 (labeled in FIG. 5) of the first non-structured light. The projection screen 608 may be the same projection screen 508 in FIG. 5. In FIG. 2, the same one or the different one of the at least one camera 216 is further configured to capture the fourth image. The fourth image reflects the fifth spatial illumination distribution. The first portion of the fourth image is caused by the first portion of the second non-structured light traveling a fourth distance to reach the same one or the different one of the at least one projection surface 214. The third distance is different from the fourth distance. In the second setup 600, the camera 306 is further configured to capture an image 620. The image 620 reflects the entire fifth spatial illumination distribution. A portion of the image 620 reflecting the illuminated portion 622 of the projection screen 608 is caused by the portion 614 of the second non-structured light.

Referring to FIG. 2, the illumination calibrating module 222 is further configured to determine the sixth spatial illumination distribution using the third image and the fourth image. The first portion of the third image and the first portion of the fourth image cause the same portion of the sixth spatial illumination distribution. Referring to FIGS. 2, 5 and 6, the illumination calibrating module 222 is configured to determine the sixth spatial illumination distribution using the image 520 and the image 620. A portion of the image 520 corresponding to the illuminated portion 522 of the projection screen 508 and a portion of the image 620 corresponding to the illuminated portion 622 of the projection screen 608 cause a same portion of the sixth spatial illumination distribution. The sixth spatial illumination distribution is a calibrated version of a spatial illumination distribution of the non-structured light illuminator 304. The fourth spatial illumination distribution and the fifth spatial illumination distribution are originated from the spatial illumination distribution of non-structured light illuminator 304. Calibration of the spatial illumination distribution of the non-structured light illuminator 304 may involve performing extrapolation on the fourth spatial illumination distribution and the fifth spatial illumination distribution, to obtain the sixth spatial illumination distribution. Other setups such that interpolation is performed for calibrating the spatial illumination distribution of the non-structured light illuminator 304 is within the contemplated scope of the present disclosure. Intensity information of the sixth spatial illumination distribution is calibrated using the inverse-square law. Calibration of the spatial illumination distribution of the non-structured light illuminator 304 may use the distances d₃ and d₄. The spatial illumination distribution of the non-structured light illuminator 304 is static throughout the structured light-based face recognition system 200 (shown in FIG. 1) illuminating the face of the target user with non-structured light and capturing non-structured light illuminated face of the target user, and therefore may be pre-calibrated using the to first setup 500 and the second setup 600.

FIG. 7 is a block diagram illustrating a hardware system 700 for implementing a software module 220 (shown in FIG. 2) for displaying the first rendered 3D face model in accordance with an embodiment of the present disclosure. The hardware system 700 includes at least one processor 702, at least one memory 704, a storage module 706, a network interface 708, an input and output (I/O) module 710, and a bus 712. The at least one processor 702 sends signals directly or indirectly and/or receives signals directly or indirectly from the at least one memory 704, the storage module 706, the network interface 708, and the I/O module 710. The at least one memory 704 is configured to store program instructions to be executed by the at least one processor 702 and data accessed by the program instructions. The at least one memory 704 includes a random access memory (RAM), other volatile storage device, and/or read only memory (ROM), or other non-volatile storage device. The at least one processor 702 is configured to execute the program instructions, which configure the at least one processor 702 as the software module 220 for displaying the first rendered 3D face model. The network interface 708 is configured access program instructions and data accessed by the program instructions stored remotely through a network. The I/O module 710 includes an input device and an output device configured for enabling user interaction with the hardware system 700. The input device includes, for example, a keyboard, or a mouse. The output device includes, for example, a display, or a printer. The storage module 706 is configured for storing program instructions and data accessed by the program instructions. The storage module 706 includes, for example, a magnetic disk, or an optical disk.

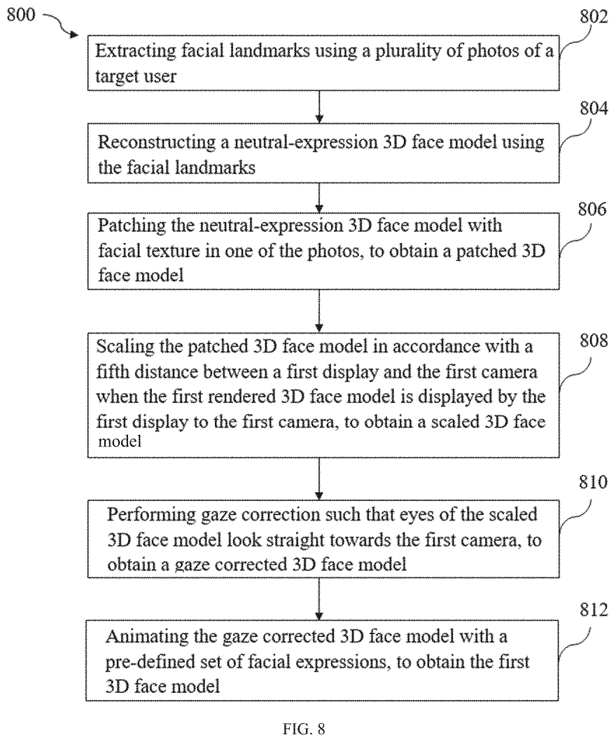

FIG. 8 is a flowchart illustrating a method 800 for building the first 3D face model in accordance with an embodiment of the present disclosure. The method 800 is performed by the 3D face model building module 226. In step 802, facial landmarks are extracted using a plurality of photos of the target user. The facial landmarks may be extracted using a supervised descent method (SDM). In step 804, a neutral-expression 3D face model is reconstructed using the facial landmarks. In step 806, the neutral-expression 3D face model is patched with facial texture in one of the photos, to obtain a patched 3D face model. The facial texture in the one of the photos is mapped to the neutral-expression 3D face model. In step 808, the patched 3D face model is scaled in accordance with a fifth distance between a first display and the first camera (described with reference to FIG. 2) when the first rendered 3D face model is displayed by the first display to the first camera, to obtain a scaled 3D face model. The first display is the display 236 (shown in FIG. 2). The fifth distance is exemplarily illustrated as a distance d₅ between a display 916 and the camera 306 in FIG. 9. The step 808 may further include positioning the display 236 in front of the first camera at the fifth distance before the patched 3D face model is scaled. Alternatively, the display 236 is positioned in front of the first camera at the fifth distance after the step 808. The step 808 is for geometry information of the first rendered 3D face model (described with reference to FIG. 2) obtained by the structured light-based face recognition system 200 (shown in FIG. 1) to match geometry information of the face of the target user stored in the structured light-based face recognition system 200. In step 810, gaze correction is performed such that eyes of the scaled 3D face model look straight towards the first camera, to obtain a gaze corrected 3D face model. In step 812, the gaze corrected 3D face model is animated with a pre-defined set of facial expressions, to obtain the first 3D face model. Examples of the steps 802, 804, 806, 810, and 812 are described in more detail in “Virtual U: Defeating face liveness detection by building virtual models from your public photos,” Yi Xu, True Price, Jan-Michael Frahm, and Fabian Monrose, In USENIX security symposium, pp. 497-512, 2016.

In method 800, scaling is performed on a 3D morphable face model. Alternatively, scaling may be performed on a face model reconstructed using shape from shading (SFS). A person having ordinary skill in the art will understand that other face model reconstruction alternatives now known or hereafter developed, may be used for building the first 3D face model to be rendered.

FIG. 9 is a structural diagram illustrating a setup 900 for displaying the first rendered 3D face model to the camera 306 in accordance with an embodiment of the present disclosure. Referring to FIGS. 2 and 9, the setup 900 is for implementing a step performed by the display 236. In FIG. 2, the display 236 is configured to display the first rendered 3D face model to the first camera. In the setup 900, a display 916 is configured to display a rendered 3D face model 909 to the camera 306 during time separated from time of static structured light illumination. The structured light projector 302 and the non-structured light illuminator 304 are covered by the lens covers. The rendered 3D face model 909 is a spoofed face illuminated by structured light with the spatial point cloud distribution of the structured light projector 302 described with reference to FIG. 4, and non-structured light with the spatial illumination distribution of the non-structured light illuminator 304 described with reference to FIG. 6. The rendered 3D face model 909 includes a plurality of point clouds deformed by the first 3D face model described with reference to FIG. 2 and a portion 918 of the face illuminated only by the non-structured light with the spatial illumination distribution of the non-structured light illuminator 304. A point cloud 910 deformed by the first 3D face model is illustrated as an example. Other point clouds deformed by the first 3D face model are not shown in FIG. 9 for simplicity.

FIG. 10 is a structural diagram illustrating a setup 1000 for calibrating dynamic structured light illumination and displaying a first rendered 3D face model to a camera in accordance with an embodiment of the present disclosure. Compared to the first setup 300 in FIG. 3, the second setup 400 in FIG. 4, and the setup 900 in FIG. 9 which are for calibrating static structured light illumination and displaying the first 3D face model rendered with the static structured light illumination, the setup 1000 is for calibrating dynamic structured light illumination and displaying the first 3D face model rendered with the dynamic structured light illumination. In FIG. 2, the structured light projector 204 is configured to project to the one of the at least one projection surface 214 with only the first structured light. The one of the at least one projection surface 214 is configured to display the first spatial illumination distribution caused only by the first structured light. The structured light projector 204 is further configured to project to the same one or the different one of the at least one projection surface 214 with only the second structured light. The same one or the different one of the at least one projection surface 214 is further configured to display the second spatial illumination distribution caused only by the second structured light. Compared to the first setup 300 and the second setup 400 which generate the first structured light and the second structured light correspondingly at time t₁ and time t₂, the setup 1000 generate the first structured light and the second structured light at the same time. In the setup 1000, a structured light projector 1002 is configured to project to a projection screen 1020 and a projection screen 1022 with only third structured light. The third structured light is reflected by a reflecting optical element 1024 and split by a splitting optical element 1026 into the first structured light and the second structured light correspondingly traveling to the projection screen 1020 and the projection screen 1022. The reflecting optical element 1024 may be a mirror. The splitting optical element 1026 may be a 50:50 beam splitter. The projection screen 1020 is located with respect to the structured light projector 1002 such that a corner 1034 of a first point cloud 1033 is caused by a portion 1032 of the first structured light traveling a distance d₆ (not labeled) to reach the projection screen 1020. The projection screen 1022 is located with respect to the structured light projector 1002 such that a corner 1037 of a second point cloud 1038 is caused by a portion 1036 of the second structured light traveling a distance d₇ (not labeled) to reach the projection screen 1022. The distance d₇ is longer than the distance d₆. In FIG. 2, the one of the at least one camera 216 is configured to capture the first image. The first image reflects the first spatial illumination distribution. The same one or the different one of the at least one camera 216 is further configured to capture the second image. The second image reflects the second spatial illumination distribution. Compared to the first setup 300 and the second setup 400 which correspondingly capture the image 320 and the image 420 using the camera 306, the setup 1000 captures an image 1044 and an image 1046 correspondingly using the camera 1040 and the camera 1042. The image 1044 reflects an entire first spatial point cloud distribution. The image 1046 reflects an entire second point cloud distribution.

Referring to FIG. 2, the illumination calibrating module 222 is configured to determine the third spatial illumination distribution using the first image and the second image. Referring to FIGS. 3, 4 and 10, compared to the illumination calibrating module 222 that calibrates the spatial point cloud distribution of the structured light projector 302 in FIGS. 3 and 4 using the distances d₁ and d₂, the illumination calibrating module 222 for the setup 1000 calibrates a spatial point cloud distribution of the structured light projector 1002 using a first total distance and a second total distance. The first total distance is a sum of a distance of a path between the structured light projector 1002 and the reflecting optical element 1024 along which a portion 1028 of the third structured light travels, a distance of a path between the reflecting optical element 1024 and the splitting optical element 1026 along which a portion 1030 of the third structured light travels, and a distance of a path between the splitting optical element 1026 and the projection screen 1020 along which the portion 1032 of the first structured light travels. The second total distance is a sum of the distance of the path between the structured light projector 1002 and the reflecting optical element 1024 along which the portion 1028 of the third structured light travels, a distance of the path between the reflecting optical element 1024 and the splitting optical element 1026 along which the portion 1030 of the third structured light travels, and a distance of a path between the splitting optical element 1026 and the projection screen 1022 along which the portion 1036 of the second structured light travels.

Referring to FIG. 10, a spatial illumination distribution of a non-structured light illuminator 1004 may be static and pre-calibrated using the first setup 500 in FIG. 5 and the second 30 setup 600 in FIG. 6. The non-structured light illuminator 1004 is covered by lens cover in the setup 1000. Alternatively, a spatial illumination distribution of the non-structured light illuminator 1004 may be dynamic and calibrated together with the spatial point cloud distribution of the structured light projector 1002. The spatial illumination distribution of the non-structured light illuminator 1004 may be calibrated similarly as the spatial point cloud distribution of the structured light projector 1002.

Referring to FIG. 2, the display 236 is configured to display the first rendered 3D face model to the first camera. Compared to the setup 900 in FIG. 9 which displays the rendered 3D face model 909 to the camera 306 during the time separated from the time of the static structured light illumination, a display 1016 in FIG. 10 is configured display a plurality of rendered 3D face models to the camera 1006 during time overlapped with time of the dynamic structured light illumination. One 1009 of the rendered 3D face models is exemplarily illustrated in FIG. 10. The rendered 3D face model 1009 may be rendered similarly as the rendered 3D face model 909.

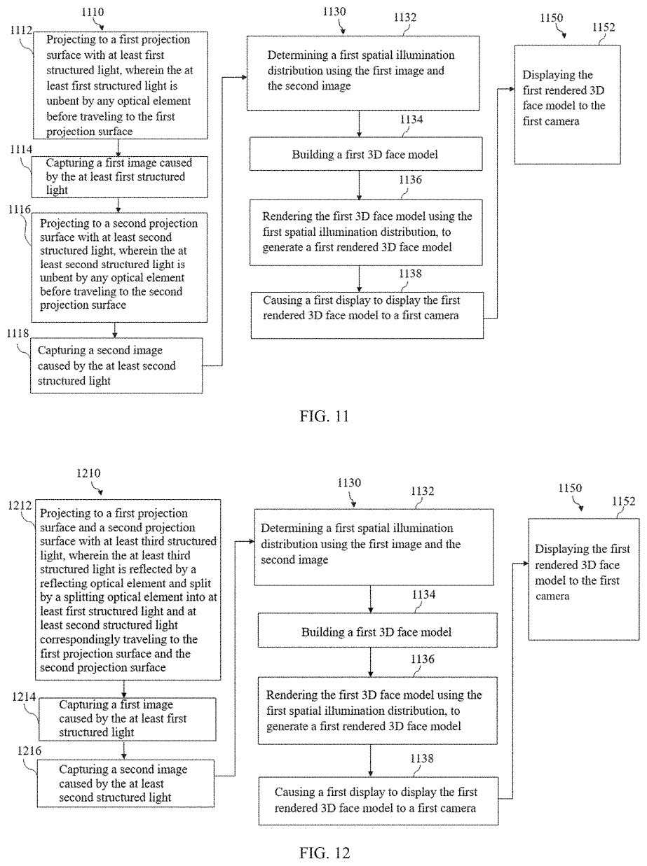

FIG. 11 is a flowchart illustrating a method for generating a spoofed structured light illuminated face in accordance with an embodiment of the present disclosure. Referring to FIGS. 2, 3, 4, and 7, the method for generating the spoofed structured light illuminated face includes a method 1110 performed by or with the at least structured light projector 202, the at least one projection surface 214, and the at least one camera 216, a method 1130 performed by the at least one processor 702, and a method 1150 performed by the display 236.

In step 1112, projection with at least first structured light is performed to a first projection surface by the at least structured light projector 202. The first projection surface is one of the at least one projection surface 214. The at least first structured light is unbent by any optical element before traveling to the first projection surface using the first setup 300. In step 1114, a first image caused by the at least first structured light is captured by the at least one camera 216. In step 1116, projection with at least second structured light is performed to a second projection surface by the at least structured light projector 202. The second projection surface is the same one or a different one of the at least one projection surface 214. The at least second structured light is unbent by any optical element before traveling to the second projection surface using the second setup 400. In step 1118, a second image caused by the at least second structured light is captured by the at least one camera 216. In step 1132, a first spatial illumination distribution is determined using the first image and the second image by the illumination calibrating module 222 for the first setup 300 and the second setup 400. In step 1134, a first 3D face model is built by the 3D face model building module 226. In step 1136, the first 3D face model is rendered using the first spatial illumination distribution, to generate a first rendered 3D face model by the 3D face model rendering module 230. In step 1138, a first display is caused to display the first rendered 3D face model to a first camera by the display controlling module 234. The first display is the display 236. In step 1152, the first rendered 3D face model is displayed to the first camera by the display 236.

FIG. 12 is a flowchart illustrating a method for generating a spoofed structured light illuminated face in accordance with another embodiment of the present disclosure. Referring to FIGS. 2, 7, and 10, compared to the method for generating the spoofed structured light illuminated face described with reference to FIG. 11, the method for generating the spoofed structured light illuminated face includes a method 1210 performed by or with the at least structured light projector 202, the at least one projection surface 214, and the at least one camera 216 instead of the method 1110.

In step 1212, projection with at least third structured light is performed to a first projection surface and a second projection surface by the at least structured light projector 202. The first projection surface is one of the at least one projection surface 214. The second projection surface is a different one of the at least one projection surface. The at least third structured light is reflected by a reflecting optical element and split by a splitting optical element into at least first structured light and at least second structured light correspondingly traveling to the first projection surface and the second projection surface using the setup 1000. In step 1214, a first image caused by the at least first structured light is captured by the at least one camera 216. In step 1216, a second image caused by the at least second structured light is captured by the at least one camera 216.

Some embodiments have one or a combination of the following features and/or advantages. In an embodiment, a spatial illumination distribution of at least structured light projector of a structured light-based face recognition system is calibrated by determining a first spatial illumination distribution using a first image caused by at least first structured light and a second image caused by at least second structure light. A first portion of the first image is caused by a first portion of the at least first structured light traveling a first distance. A first portion of the second image is caused by a first portion of the at least second structured light traveling a second distance. The first portion of the first image and the first portion of the second image cause a same portion of the first spatial illumination distribution. The first distance is different from the second distance. A first 3D face model of a target user is rendered using the first spatial illumination distribution, to generate a first rendered 3D face model. The first rendered 3D face model is displayed by a first display to a first camera of the structured light-based face recognition system. Therefore, a simple, fast, and accurate method for calibrating the spatial illumination distribution of the at least structured light projector is provided for testing the structured light-based face recognition system, which is a 3D face recognition system. In an embodiment, scaling is performed such that the first 3D face model is scaled in accordance with a distance between the first display and the first camera when the first rendered 3D face model is displayed by the first display to the first camera. Hence, geometry information of the first rendered 3D face model obtained by the structured light-based face recognition system may match geometry information of the face of the target user stored in the structured light-based face recognition system during testing.

A person having ordinary skill in the art understands that each of the units, modules, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure.

It is understood by a person having ordinary skill in the art that he/she can refer to the working processes of the system, device, and module in the above-mentioned embodiment since the working processes of the above-mentioned system, device, and module are basically the same. For easy description and simplicity, these working processes will not be detailed.

It is understood that the disclosed system, device, and method in the embodiments of the present disclosure can be realized with other ways. The above-mentioned embodiments are exemplary only. The division of the modules is merely based on logical functions while other divisions exist in realization. It is possible that a plurality of modules or components are combined or integrated in another system. It is also possible that some characteristics are omitted or skipped. On the other hand, the displayed or discussed mutual coupling, direct coupling, or communicative coupling operate through some ports, devices, or modules whether indirectly or communicatively by ways of electrical, mechanical, or other kinds of forms.

The modules as separating components for explanation are or are not physically separated. The modules for display are or are not physical modules, that is, located in one place or distributed on a plurality of network modules. Some or all of the modules are used according to the purposes of the embodiments.

Moreover, each of the functional modules in each of the embodiments can be integrated in one processing module, physically independent, or integrated in one processing module with two or more than two modules.

If the software function module is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method, comprising:
determining, by at least one processor, a first spatial illumination distribution using a first image caused by at least first structured light and a second image caused by at least second structured light, wherein a first portion of the first image is caused by a first portion of the at least first structured light traveling a first distance, a first portion of the second image is caused by a first portion of the at least second structured light traveling a second distance, the first portion of the first image and the first portion of the second image cause a same portion of the first spatial illumination distribution, and the first distance is different from the second distance:
building, by the at least one processor, a first 3D face model;
rendering, by the at least one processor, the first 3D face model using the first spatial illumination distribution, to generate a first rendered 3D face model; and
displaying, by a first display, the first rendered 3D face model to a first camera for testing a face recognition system.

2. The method of claim 1, wherein:
the step of determining the first spatial illumination distribution using the first image caused by the at least first structured light and the second image caused by the at least second structured light comprises:
determining the first spatial illumination distribution using the first image caused only by the first structured light and the second image caused only by the second structured light, wherein the first portion of the first image is caused by a first portion of the first structured light traveling the first distance, the first portion of the second image is caused by a first portion of the second structured light traveling the second distance; and
the method further comprises:
determining a second spatial illumination distribution using a third image caused only by first non-structured light and a fourth image caused only by second non-structured light, wherein a first portion of the third image is caused by a first portion of the first non-structured light traveling a third distance, a first portion of the fourth image is caused by a first portion of the second non-structured light traveling a fourth distance, the first portion of the third image and the first portion of the fourth image cause a same portion of the second spatial illumination distribution, and the third distance is different from the fourth distance.

3. The method of claim 2, further comprising:
illuminating a first projection surface with the first non-structured light;
capturing the third image, wherein the third image reflects a third spatial illumination distribution on the first projection surface illuminated by the first non-structured light;
illuminating a second projection surface with the second non-structured light; and
capturing the fourth image, wherein the fourth image reflects a fourth spatial illumination distribution on the second projection surface illuminated by the second non-structured light;
wherein the first projection surface is or is not the second projection surface.

4. The method of claim 1, further comprising:
projecting to a first projection surface with the at least first structured light, wherein the at least first structured light is unbent by any optical element before traveling to the first projection surface; and
capturing the first image, wherein the first image reflects a fifth spatial illumination distribution on the first projection surface illuminated by the at least first structured light;
projecting to a second projection surface with the at least second structured light, wherein the at least second structured light is unbent by any optical element before traveling to the second projection surface; and
capturing the second image, wherein the second image reflects a sixth spatial illumination distribution on the second projection surface illuminated by the at least second structured light;
wherein the first projection surface is or is not the second projection surface.

5. The method of claim 1, further comprising:
projecting to a first projection surface and a second projection surface with at least third structured light, wherein the at least third structured light is reflected by a reflecting optical element and split by a splitting optical element into the at least first structured light and the at least second structured light correspondingly traveling to the first projection surface and the second projection surface;
capturing the first image, wherein the first image reflects a seventh spatial illumination distribution on the first projection surface illuminated by the at least first structured light; and
capturing the second image, wherein the second image reflects an eighth spatial illumination distribution on the second projection surface illuminated by the at least second structured light.

6. The method of claim 1, further comprising:
capturing the first image and the second image by at least one camera.

7. The method of claim 1, wherein the step of building the first 3D face model comprises:
perform scaling such that the first 3D face model is scaled in accordance with a fifth distance between the first display and the first camera when the first rendered 3D face model is displayed by the first display to the first camera.

8. The method of claim 1, wherein the step of building the 3D face model comprises:
extracting facial landmarks using a plurality of photos of a target user;
reconstructing a neutral-expression 3D face model using the facial landmarks;
patching the neutral-expression 3D face model with facial texture in one of the photos, to obtain a patched 3D face model;
scaling the patched 3D face model in accordance with a fifth distance between the first display and the first camera when the first rendered 3D face model is displayed by the first display to the first camera, to obtain a scaled 3D face model;
performing gaze correction such that eyes of the scaled 3D face model look straight towards the first camera, to obtain a gaze corrected 3D face model; and
animating the gaze corrected 3D face model with a pre-defined set of facial expressions, to obtain the first 3D face model.

9. A system, comprising:
at least one memory configured to store program instructions;
at least one processor configured to execute the program instructions, which cause the at least one processor to perform steps comprising:
determining a first spatial illumination distribution using a first image caused by at least first structured light and a second image caused by at least second structured light, wherein a first portion of the first image is caused by a first portion of the at least first structured light traveling a first distance, a first portion of the second image is caused by a first portion of the at least second structured light traveling a second distance, the first portion of the first image and the first portion of the second image cause a same portion of the first spatial illumination distribution, and the first distance is different from the second distance;
building a first 3D face model; and
rendering the first 3D face model using the first spatial illumination distribution, to generate a first rendered 3D face model; and
a first display configured to display the first rendered 3D face model to a first camera for testing a face recognition system.

10. The system of claim 9, wherein:
the step of determining the first spatial illumination distribution using the first image caused by the at least first structured light and the second image caused by the at least second structured light comprises:
determining a first spatial illumination distribution using the first image caused only by the first structured light and the second image caused only by the second structured light, wherein the first portion of the first image is caused by a first portion of the first structured light traveling the first distance, the first portion of the second image is caused by a first portion of the second structured light traveling the second distance; and
wherein the program instructions further cause the at least one processor to:
determine a second spatial illumination distribution using a third image caused only by first non-structured light and a fourth image caused only by second non-structured light, wherein a first portion of the third image is caused by a first portion of the first non-structured light traveling a third distance, a first portion of the fourth image is caused by a first portion of the second non-structured light traveling a fourth distance, the first portion of the third image and the first portion of the fourth image cause a same portion of the second spatial illumination distribution, and the third distance is different from the fourth distance.

11. The system of claim 10, further comprising:
a first projection surface configured to be illuminated with the first non-structured light, wherein a third spatial illumination distribution on the first projection surface is reflected in the third image, and the third image is captured by the first camera; and
a second projection surface configured to be illuminated with the second non-structured light, wherein a fourth spatial illumination distribution on the second projection surface is reflected in the fourth image, and the fourth image is captured by the first camera;
wherein the first projection surface is or is not the second projection surface.

12. The system of claim 10, further comprising:
a first non-structured light illuminator;
a first projection surface and a second projection surface, wherein the first projection surface is or is not the second projection surface; and
a second camera, wherein the second camera is or is not the first camera;
wherein:
the first non-structured light illuminator is configured to illuminate the first projection surface with the first non-structured light;
the second camera is configured to capture the third image, wherein the third image reflects a third spatial illumination distribution on the first projection surface illuminated by the first non-structured light;
the first non-structured light illuminator is further configured to illuminate the second projection surface with the second non-structured light; and
the second camera is further configured to capture the fourth image, wherein the fourth image reflects a fourth spatial illumination distribution on the second projection surface illuminated by the second non-structured light.

13. The system of claim 9, further comprising:
a first projection surface configured for projection with the at least first structured light to be performed to the first projection surface, wherein the at least first structured light is unbent by any optical element before traveling to the first projection surface, a fifth spatial illumination distribution on the first projection surface is reflected in the first image, and the first image is captured by the first camera; and
a second projection surface configured for projection with the at least second structured light to be performed to the second projection surface, wherein the at least second structured light is unbent by any optical element before traveling to the second projection surface, a sixth spatial illumination distribution on the second projection surface is reflected in the second image, and the second image is captured by the first camera;
wherein the first projection surface is or is not the second projection surface.

14. The system of claim 9, further comprises:
at least first structured light projector;
a first projection surface and a second projection surface, wherein the first projection surface is or is not the second projection surface; and
a second camera, wherein the second camera is or is not the first camera;
wherein
the at least first structured light projector is configured to project to the first projection surface with the at least first structured light, wherein the at least first structured light is unbent by any optical element before traveling to the first projection surface;
the second camera is configured to capture the first image, wherein the first image reflects a fifth spatial illumination distribution on the first projection surface illuminated by the at least first structured light;
the at least first structured light projector is further configured to project to the second projection surface with the at least second structured light, wherein the at least second structured light is unbent by any optical element before traveling to the second projection surface; and
the second camera is further configured to capture the second image, wherein the second image reflects a sixth spatial illumination distribution on the second projection surface illuminated by the at least second structured light.

15. The system of claim 9, further comprising:
a first projection surface and a second projection surface configured for projection with at least third structured light to be performed to the first projection surface and the second projection surface;
wherein
the at least third structured light is reflected by a reflecting optical element and split by a splitting optical element into the at least first structured light and the at least second structured light correspondingly traveling to the first projection surface and the second projection surface;
a seventh spatial illumination distribution on the first projection surface is reflected in the first image, and the first image is captured by the first camera; and
an eighth spatial illumination distribution on the second projection surface is reflected in the second image, and the second image is captured by the first camera.

16. The system of claim 9, further comprising:
at least first structured light projector;
a first projection surface and a second projection surface; and
a second camera;
a third camera;
wherein:
the at least first structured light projector is configured to project to the first projection surface and the second projection surface with at least third structured light;
the at least third structured light is reflected by a reflecting optical element and split by a splitting optical element into the at least first structured light and the at least second structured light correspondingly traveling to the first projection surface and the second projection surface;
the second camera is configured to capture the first image, wherein the first image reflects a seventh spatial illumination distribution on the first projection surface illuminated by the at least first structured light; and
the third camera is configured to capture the second image, wherein the second image reflects an eighth spatial illumination distribution on the second projection surface illuminated by the at least second structured light.

17. The system of claim 9, further comprises:
at least one camera configured to capture the first image and the second image.

18. The system of claim 9, wherein the step of building the first 3D face model comprises:
perform scaling such that the first 3D face model is scaled in accordance with a fifth distance between the first display and the first camera when the first rendered 3D face model is displayed by the first display to the first camera.

19. The system of claim 9, wherein the step of building the 3D face model comprises:
extracting facial landmarks using a plurality of photos of a target user;
reconstructing a neutral-expression 3D face model using the facial landmarks;
patching the neutral-expression 3D face model with facial texture in one of the photos, to obtain a patched 3D face model;
scaling the patched 3D face model in accordance with a fifth distance between the first display and the first camera when the first rendered 3D face model is displayed by the first display to the first camera, to obtain a scaled 3D face model;
performing gaze correction such that eyes of the scaled 3D face model look straight towards the first camera, to obtain a gaze corrected 3D face model; and
animating the gaze corrected 3D face model with a pre-defined set of facial expressions, to obtain the first 3D face model.

20. A non-transitory computer-readable medium with program instructions stored thereon, that when executed by at least one processor, cause the at least one processor to perform steps comprising:
determining a first spatial illumination distribution using a first image caused by at least first structured light and a second image caused by at least second structured light, wherein a first portion of the first image is caused by a first portion of the at least first structured light traveling a first distance, a first portion of the second image is caused by a first portion of the at least second structured light traveling a second distance, the first portion of the first image and the first portion of the second image cause a same portion of the first spatial illumination distribution, and the first distance is different from the second distance:
building a first 3D face model;
rendering the first 3D face model using the first spatial illumination distribution, to generate a first rendered 3D face model; and
causing a first display to display the first rendered 3D face model to a first camera for testing a face recognition system.
